(19) United States
(12) Patent Application Publication
(10) Pub. No.: US 2024/0428686 A1
(43) Pub. Date: Dec. 26, 2024

(54) Device and Method for Assisting a Driver of a Combination at the Start of Travel, Assistance System for a Towing Vehicle, and Computer-Readable (Storage) Medium

(71) Applicant: Bayerische Motoren Werke Aktiengesellschaft, Muenchen (DE)

(72) Inventor: Michael STROEBEL, Groebenzell (DE)

(21) Appl. No.: 18/699,154

(22) PCT Filed: Sep. 13, 2022
(86) PCT No.: PCT/EP2022/075380

§ 371 Date: Apr. 5, 2024

(30) Foreign Application Priority Data
Oct. 29, 2021 (DE) 10 2021 128 362.0

(51) Int. Cl. G08G 1/16; B60W 30/09; B62D 15/02

(52) U.S. Cl. CPC G08G 1/16; B60W 30/09; B62D 15/0265; B60W 2520/22

(57) ABSTRACT

A device for assisting, at the start of travel, a driver of a vehicle towing a trailer. The device receives environment data for the vehicle and trailer. The device determines from the environment data: a coupling angle between the towing vehicle and the trailer, and a pivoting range of the trailer. The device determines, from the environment data, that an object is located at least partly within the pivoting range of the trailer and, because of geometric concealment, is only able to be partly described by the environment data.

### CROSS REFERENCE TO RELATED APPLICATION

This application is a 371 of International Application No. PCT/EP2022/075380, filed Sep. 13, 2022 which claims priority under 35 U.S.C. § 119 from German Patent Application No. 10 2021 128 362.0, filed Oct. 29, 2021, the entire disclosure of which is herein expressly incorporated by reference.

### BACKGROUND AND SUMMARY

The present invention relates to a device and to a method for assisting a driver of a combination at the start of travel. Moreover, the present invention relates to an assistance system for a towing vehicle. Finally, the present invention relates to a computer program and to a computer-readable (storage) medium.

Assistance systems for assisting a driver of a combination comprising a towing vehicle and a coupled trailer have long been known. For example, trailer assistance systems are known in which the angle between the trailer and the towing vehicle can be adjusted continuously by means of a rotary/push adjuster when reversing the combination. Furthermore, trailer assistance systems are known which assist the driver of the towing vehicle in maneuvering the combination. For example, rear-view cameras or what are known as PDC sensors can be used for this purpose.

Document DE 10 2018 206 494 A1 discloses a method for operating a trailer maneuvering assistance system of a motor vehicle in which a maneuvering operation of a combination, made up of the motor vehicle and a trailer, into a target position is assisted by means of the trailer maneuvering assistance system. In the process, the trailer is detected by means of a sensor device of the motor vehicle when the trailer is coupled to the heavy goods vehicle. The sensor data relating to the detected trailer are transmitted to an evaluation device of the trailer maneuvering assistance system. In addition, dimensions of the trailer in the longitudinal direction, lateral direction and height direction of the trailer are determined by means of the evaluation device on the basis of the transmitted sensor data. Finally, the maneuvering operation of the combination into the target position is assisted taking into consideration the determined dimensions of the trailer.

It is the object of the present invention to specify a solution aimed at being able to improve assistance of a driver of a combination, in particular at the start of travel.

This object is achieved according to the invention by a device, an assistance system, a method, a computer program and a computer-readable (storage) medium having the features according to the independent claims. The dependent claims relate to advantageous developments of the present invention.

A device according to the invention for assisting a driver of a combination at the start of travel, wherein the combination comprises a towing vehicle and a coupled trailer, is configured to receive vicinity data describing at least a part of an environment of the towing vehicle and of the trailer. Moreover, the device for assisting the driver is configured to determine a coupling angle by means of the vicinity data, the coupling angle describing an angle between the towing vehicle and the coupled trailer. Furthermore, the device is configured to determine a swivel range of the trailer by means of the vicinity data and in dependence on the coupling angle, the swivel range describing a region in the environment through which the trailer passes due to a veering movement during the start of travel. Finally, the device is also configured to deduce the presence of at least one object in the environment by means of the vicinity data, wherein the object is located at least in part within the swivel range of the trailer and is describable only in part by the vicinity data due to a geometric obscuration.

The device according to the invention thus serves for assisting the driver of the combination at the start of travel. In particular, the driver of the combination is thus assisted following the coupling operation during which the trailer is coupled to the towing vehicle. Provision is made here for vicinity data to be received. The vicinity data can be provided by a vicinity sensor of the towing vehicle. The vicinity sensor can be designed for example as a camera, as a lidar, radar and/or ultrasonic sensor. It is also possible here that vicinity data from a plurality of vicinity sensors and/or vicinity data which are already fused are received. Moreover, it is possible for the vicinity data to be provided additionally or alternatively by an infrastructure sensor and/or a vicinity sensor of the trailer. The vicinity data always describe at least a part of the environment of the towing vehicle and of the trailer here.

Provision may be made here for at least a part of the vicinity data to already be received when the towing vehicle drives past the trailer. In particular, at least a part of the vicinity data can thus already be received while the trailer is not coupled to the towing vehicle or while the towing vehicle approaches the trailer during a coupling operation. This can have the advantage that the deduction of the presence of the at least one object in the environment by means of the vicinity data is additionally improved and the entire device thus has a higher accuracy in corresponding situations. Moreover, the at least one object may thus possibly even be detected in the environment. Consequently, such an object can be stored in a memory of the device and thus improve the process of deducing the presence of the at least one object.

A coupling angle can be determined by means of the vicinity data. The coupling angle can describe an angle between the longitudinal axis of the towing vehicle and the longitudinal axis of the coupled trailer. If the coupling angle is 0°, for example, the longitudinal axis of the towing vehicle and the longitudinal axis of the coupled trailer can be aligned parallel to one another. However, it is also possible that the trailer is not coupled to the towing vehicle in a straight line and that the coupling angle therefore is 30°, for example. When the combination begins moving at the start of travel, the coupling angle can be a decisive cause of a veering movement of the trailer. In particular, the trailer can thus veer even when the coupling angle is not equal to 0° and the towing vehicle begins moving straight ahead.

Consequently, a swivel range of the trailer can be determined by means of the vicinity data and in dependence on the coupling angle. The swivel range of the trailer during the start of travel can depend firstly on the coupling angle, but also on a steering angle of the vehicle. Consequently, the swivel range of the trailer during the start of travel can describe a veering movement due to the coupling angle both when driving straight ahead and also when driving in a bend at the start of travel.

In order now to assist the driver of the combination at the start of travel, objects can be detected in the environment of the towing vehicle and of the trailer by means of the vicinity data. However, it may be possible here that objects located at least in part within the swivel range of the trailer but cannot be described by the vicinity data due to a geometric obscuration. In such a case, it is therefore conceivable that a collision occurs at the start of travel between the trailer and the object. Although the vicinity data possibly describe only regions of such an object, it is nevertheless possible to deduce the dimensions or the presence of the object in the environment.

For example, it is conceivable that the trailer is positioned in the longitudinal direction parallel to a house wall and is coupled to a towing vehicle at a coupling angle of 30°,for example. When the vicinity data are provided in this example by a rear-view camera of the towing vehicle, it is conceivable that the trailer geometrically obscures large regions of the house wall. In other words, only some regions of the object (the house wall) are thus describable by the vicinity data. However, it is possible to deduce therefrom that at least one object, specifically the house wall, is also located in the swivel range of the trailer. On the basis of the deduced object, a warning can be output to the driver of the towing vehicle, for example.

The towing vehicle can be designed for example as a passenger car. Moreover, the towing vehicle can also be a heavy goods vehicle, a commercial vehicle, a self-propelled machine, a caravan, or the like. In particular, the towing vehicle can also be a tractor, an agricultural or forestry machine, a semi-trailer truck, a bus, or the like.

The trailer can be designed for example as a simple passenger car trailer, which may have an overrun brake and its own service brake. Moreover, boat trailers, caravans, horse trailers, semi-trailers, harvesters, or the like are likewise conceivable. Generally, the steering technology of the trailer is irrelevant here. In particular, the trailer may thus be a non-steered trailer (rigid axle). Moreover, the trailer can also have swivel axle steering or turntable steering.

The term start of travel, as is used in this document, comprises here the first few meters traveled by the combination after a standstill. For example, the term start of travel thus encompasses the first 5, 10 or 20 meters traveled by the combination.

One advantageous configuration of the device is configured to output an electrical signal to warn the driver of a collision between the trailer and the at least one object. In other words, if it is possible to deduce the presence of at least one object in the environment by means of the vicinity data, an electrical signal can be output, which is used, for example, to output a visual, acoustic and/or haptic warning to the driver of the towing vehicle. In this way, a collision between the trailer and the at least one object may optionally be prevented.

A further advantageous configuration of the device is configured to output an electrical signal to warn of non-monitorable partial regions of the swivel range, wherein the non-monitorable partial regions are not describable by means of the vicinity data due to the geometric obscuration. As described previously, it may be possible that the presence of objects in the swivel range of the trailer of which only some regions are describable by the vicinity data can be deduced if the vicinity data indicate the presence of the at least one object despite the geometric obscuration of the at least one object. However, if the vicinity data do not indicate the presence of an object in the swivel range of the trailer and for this reason the presence of no object in the swivel range of the trailer can be deduced, the driver of the towing vehicle can be notified of non-monitored partial regions of the swivel range by means of the electrical signal. The notification or the warning by means of the electrical signal can be output for example by means of a display unit, as a result of which the driver of the towing vehicle can be prompted to check the non-monitored partial regions of the swivel range again before the start of travel.

It is additionally advantageous if the device is configured to output an electrical signal to limit a steering angle of the towing vehicle, wherein a collision between the trailer and the at least one object is preventable by means of the limiting of the steering angle. So if at least one object is located in the swivel range of the trailer, which possibly leads to a collision with the trailer at the start of travel, an electrical signal can be output which limits the steering angle of the vehicle in such a way that a collision between the trailer and the at least one object can be prevented. It is conceivable here that an intervention in the steering of the towing vehicle takes place by means of a torque. Such steering interventions are known for example from what are known as steering and lane-keeping assistance systems. However, it is also conceivable that a mechanical limitation of the steering angle is implemented on the basis of the electrical signal. It is particularly advantageous if the electrical signal for limiting the steering angle is not output during the entire start of travel, or if the steering angle is not limited during the entire start of travel, but only if a collision is immediately imminent or if this may prevent the collision between the trailer and the at least one object from actually occurring.

An advantageous development of the device finally makes provision for the device to be configured to output an electrical signal for carrying out an emergency stop of the towing vehicle if a collision between the trailer and the at least one object is expectable. If the presence of at least one object is deduced in the swivel range of the trailer by means of the vicinity data, it is possible to determine when a collision between the trailer and the at least one object in the swivel range of the trailer is imminent without using further distance sensors such as, for example, PDC sensors. By triggering an emergency stop of the towing vehicle, unnecessary damage can thus be prevented. Such emergency brake assistance systems are known in particular from parking assistance systems, as they are called, and city emergency brake functions, wherein the distance sensor system of the vehicle or of the towing vehicle is explicitly used in such known functions and systems. In other words, the number of sensors can thus be reduced.

An assistance system according to the invention for a towing vehicle comprises a device according to the invention for assisting a driver of a combination at the start of travel. In addition, the assistance system comprises at least one vicinity sensor for providing the vicinity data. Finally, the assistance system for a towing vehicle comprises a display unit for presenting the warning of a collision between the trailer and the at least one object and/or for presenting the warning of non-monitorable partial regions of the swivel range.

A method according to the invention for assisting a driver of a combination at the start of travel, wherein the combination comprises a towing vehicle and a coupled trailer, comprises receiving vicinity data describing at least a part of an environment of the towing vehicle and of the trailer. The method additionally comprises determining a coupling angle by means of the vicinity data, the coupling angle describing an angle between the towing vehicle and the coupled trailer. The method further comprises determining a swivel range of the trailer by means of the vicinity data and in dependence on the coupling angle, the swivel range describing a region in the environment through which the trailer passes during the start of travel due to a veering movement. Finally, the method comprises deducing the presence of at least one object in the environment by means of the vicinity data, wherein at least some regions of the object are located within the swivel range of the trailer and only some regions of the object are describable by the vicinity data due to a geometric obscuration.

A further aspect of the invention relates to a computer program comprising instructions that, when the program is executed by a computation device, cause the latter to carry out a method according to the invention and the advantageous configurations thereof. The invention furthermore relates to a computer-readable (storage) medium comprising instructions that, when executed by a computation device, cause the latter to carry out a method according to the invention and the advantageous configurations thereof.

The preferred embodiments introduced with respect to the device according to the invention and the advantages thereof apply analogously to the assistance system according to the invention, to the method according to the invention, to the computer program according to the invention, and to the computer-readable (storage) medium according to the invention.

Further features of the invention are evident from the claims, the figures, and the description of the figures. The features and combinations of features mentioned previously in the description and the features and combinations of features that will be stated below in the description of the figures and/or are shown in the figures alone can be used not only in the respectively stated combination but also in a different combination or alone, without departing from the scope of the invention.

The invention will now be explained in more detail on the basis of preferred exemplary embodiments and with reference to the attached drawings, in which:

### BRIEF DESCRIPTION OF THE DRAWINGS

FIG. 1 shows a schematic illustration of a combination, wherein the towing vehicle of the combination has an assistance system for assisting a driver of a combination at the start of travel, and

FIG. 2 shows a schematic illustration of a combination at the start of travel, wherein an object is located in the swivel range of the trailer, with only some regions of the object being describable by the vicinity data due to a geometric obscuration.

### DETAILED DESCRIPTION OF THE DRAWINGS

The same or functionally same elements are provided with the same reference signs in the Figures.

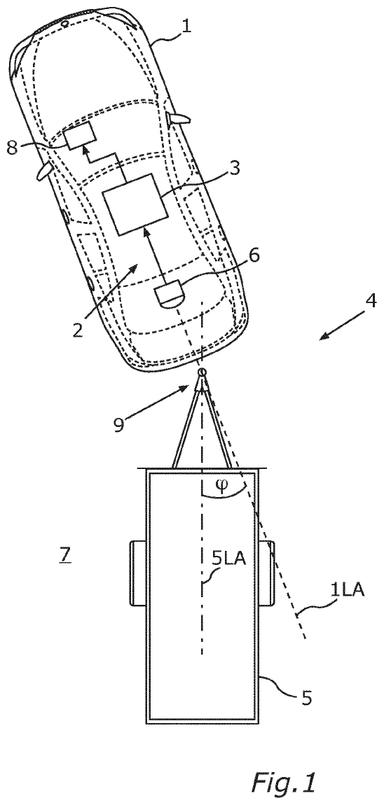

FIG. 1 shows a schematic illustration of an exemplary embodiment for an assistance system 2 according to the invention for a towing vehicle 1 of a combination 4. The assistance system 2 comprises here a device 3 for assisting a driver of a combination 4 at the start of travel 13. The combination 4 comprises a towing vehicle 1 and a coupled trailer 5. The assistance system 2 moreover comprises at least one vicinity sensor 6 for providing vicinity data describing at least a part of an environment 7 of the towing vehicle 1 and of the trailer 5. The assistance system 2 further comprises a display unit 8 for presenting warnings. The trailer 5 and the towing vehicle 1 are arranged at a coupling angle o to one another. The trailer 5 is coupled here to the towing vehicle 1 by means of a trailer coupling 9. The coupling angle q can describe an angle between the towing vehicle longitudinal axis 1LA and the trailer longitudinal axis 5LA.

The device 3 can receive vicinity data from the vicinity sensor 6. FIG. 1 shows the vicinity sensor 6 as a camera or rear-view camera. The vicinity sensor 6 can, however, also be a lidar, radar, ultrasonic sensor and/or the like. It is additionally conceivable that a plurality of vicinity sensors 6 are combined or that their vicinity data are fused.

The coupling angle φ can be determined by means of the vicinity data from the rear-view camera or the vicinity sensor 6. Moreover, a swivel range 10 of the trailer 5 can be determined by means of the vicinity data and in dependence on the coupling angle φ. The swivel range 10 of the trailer 5 here marks that part of the environment 7 through which the trailer 5 passes during the start of travel 13 due to a veering movement of the trailer. If an object is now located in the environment 7 of which at least some regions are arranged within the swivel range 10 of the trailer 5, but of which only some regions are describable by the vicinity data from the vicinity sensor 6 due to a geometric obscuration 11, it is still possible to deduce the presence of the object. Next, the device 3 can output an electrical signal to warn the driver and/or to limit a steering angle of the towing vehicle 1 and/or to carry out an emergency stop of the towing vehicle 1. When an electrical signal is output to warn the driver of the towing vehicle 1, the electrical signal can be presented for example by means of a display unit 8.

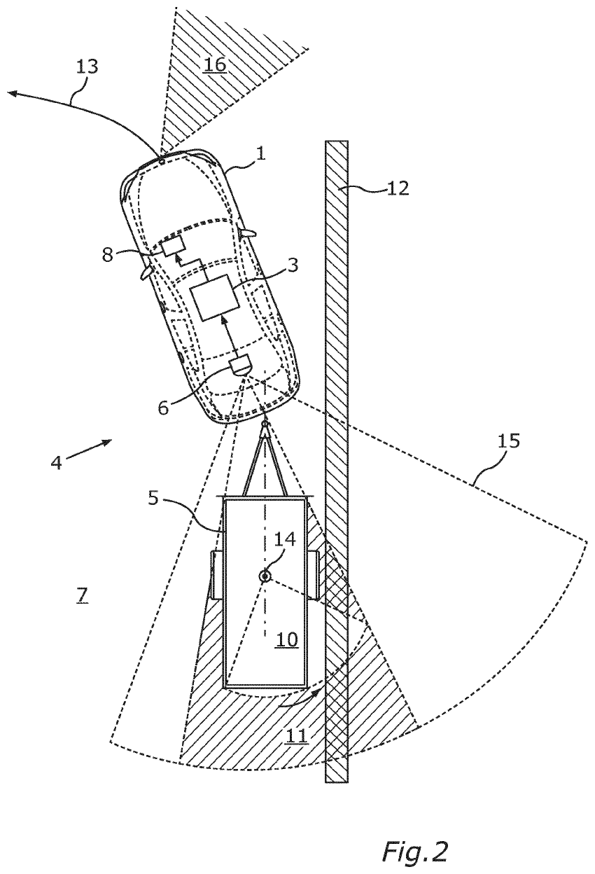

FIG. 2 shows a schematic illustration of the combination 4, wherein the trailer 5 of the combination 4 is positioned directly next to a house wall 12. In addition, the towing vehicle 1 and the trailer 5 enclose a coupling angle q of approximately 30°. Due to the coupling angle φ and the trajectory of the start of travel 13, there is a risk of the trailer 5 colliding with the house wall 12. During the start of travel 13, the rear of the trailer 5 swivels. This swivel range 10 can be determined by means of the vicinity data from the vicinity sensor 6 and in dependence on the coupling angle φ. The swivel range 10 of the trailer 5 describes the region in the environment 7 through which the trailer passes due to a veering movement and is the result of a rotation of the rear of the trailer 5 about the axis center 14.

The theoretically possible detection region 15 of the vicinity sensor 6 can be limited due to a geometric obscuration 11 by the trailer 5. Consequently, it is not possible to directly monitor the swivel range 10 of the trailer 5 using the vicinity sensor 6. However, it is possible to deduce the presence of an object which is, for example, greater than the region that is not monitored due to the geometric obscuration 11, by means of the vicinity data. In FIG. 2, some regions of the house wall 12 are describable by the vicinity data from the vicinity sensor 6. Due to the part of the house wall 12 that is describable by means of the vicinity data, it is thus also possible to deduce the presence of at least one object in the environment 7, of which at least some regions are located within the swivel range 10 of the trailer 5.

On this basis, the device 3 can output for example an electrical signal to warn the driver of a collision between the trailer 5 and the house wall 12.

Additionally, or alternatively, the device 3 can output an electrical signal to limit the steering angle of the towing vehicle 1. By means of the limited steering angle, it might thus be possible to prevent a collision between the trailer 5 and the house wall 12. For example, the steering angle can be limited in such a way that a trajectory during the start of travel 13 is possible only in the region 16. It is also conceivable that an electrical signal is continuously output to warn the driver if the trajectory during the start of travel 13 does not lie within the region 16. Such a warning can be output for example in the form of a vibrating steering wheel. It is thus possible to prevent a collision between the trailer 5 during the start of travel 13 and the house wall 12.

1-8. (canceled)

9. A device for assisting, at a start of travel, a driver of a vehicle towing a coupled trailer, the device comprising:
a controller configured to:
receive vicinity data describing at least a part of an environment of the vehicle and of the trailer,
determine a coupling angle from the vicinity data, wherein the coupling angle describes an angle between the vehicle and the trailer,
determine a swivel range of the trailer from the vicinity data and in dependence on the coupling angle, wherein the swivel range describes a region in the environment through which the trailer passes during the start of travel due to a veering movement, and
deduce the presence of at least one object in the environment from the vicinity data, wherein at least some regions of the object are located within the swivel range of the trailer and only some regions are describable by the vicinity data due to a geometric obscuration.

10. The device of claim 9, wherein the controller is further configured to output an electrical signal to warn the driver of a collision between the trailer and the at least one object.

11. The device of claim 9,
wherein the controller is further configured to output an electrical signal to warn of non-monitorable partial regions of the swivel range, and
wherein the non-monitorable partial regions are not describable by means of the vicinity data due to the geometric obscuration.

12. The device of claim 9,
wherein the controller is further configured to output an electrical signal to limit a steering angle of the towing vehicle,
wherein a collision between the trailer and the at least one object is preventable by means of the limiting of the steering angle.

13. The device of claim 9, where the controller is further configured to output an electrical signal for carrying out an emergency stop of the towing vehicle if a collision between the trailer and the at least one object is expectable.

14. An assistance system, comprising:
the device according to claim 10,
at least one vicinity sensor configured to provide the vicinity data, and
a display unit for presenting the warning of a collision between the trailer and the at least one object and/or for presenting the warning of non-monitorable partial regions of the swivel range.

15. A method for assisting, at a start of travel, a driver of a vehicle towing a trailer, comprising:
receiving vicinity data describing at least a part of an environment of the vehicle and of the trailer,
determining a coupling angle from the vicinity data, wherein the coupling angle describes an angle between the towing vehicle and the trailer,
determining a swivel range of the trailer from the vicinity data and in dependence on the coupling angle, wherein the swivel range describes a region in the environment through which the trailer passes during the start of travel due to a veering movement, and
deducing the presence of at least one object in the environment via the vicinity data, wherein at least some regions of the object are located within the swivel range of the trailer and only some regions are describable by the vicinity data due to a geometric obscuration.

16. A non-transitory medium having stored thereon a set of instructions whose execution by a computer causes the computer to carry out the method of claim 15.
